(19) United States
(12) Patent Application Publication
(10) Pub. No.: US 2026/0218750 A1
(43) Pub. Date: Jul. 30, 2026

(54) WHEEL BEARING UNIT FOR A VEHICLE

(71) Applicant: AUDI AG, lngolstadt (DE)

(72) Inventors: Johannes ALBL, Ingolstadt (DE); Michael FRISCH, Schönberg (DE)

(73) Assignee: AUDI AG, lngolstadt (DE)

(21) Appl. No.: 19/145,108

(22) PCT Filed: Dec. 5, 2023
(86) PCT No.: PCT/EP2023/084351

§ 371 Date: Jul. 1, 2025

(30) Foreign Application Priority Data
Feb. 23, 2023 (DE) 10 2023 104 492.3

(51) Int. Cl. F16C 33/64; F16C 19/52; F16C 33/62; F16C 35/063

(52) U.S. Cl. CPC F16C 33/64; F16C 19/527; F16C 33/62; F16C 35/063; F16C 2204/50; F16C 2223/40; F16C 2326/02

(57) ABSTRACT

A wheel bearing unit for a vehicle, having a wheel bearing which has at least one internal ring arranged fixedly on a bearing seat of a hollow cylindrical hub portion of a wheel hub. The hub portion can be connected in a torque-transmitting manner to a joint bell of a constant velocity joint of a cardan shaft of the vehicle, and the joint bell axially preloads the internal ring against the bearing seat of the hub portion of the wheel hub. Contact surfaces between the internal ring and the bearing seat and/or between the internal ring and the joint bell are coated with an adhesive friction-reducing layer.

### FIELD

The invention relates to a wheel bearing unit for a vehicle and to a method for manufacturing such a wheel bearing unit. In addition, the invention relates to a vehicle with such a wheel bearing unit.

### BACKGROUND

A wheel bearing unit of the generic type has a wheel bearing with at least one internal ring which is firmly seated on a bearing seat of a hollow cylindrical hub portion of a wheel hub. The hub portion of the wheel hub is connected in a torque-transmitting manner to a joint bell of a constant velocity joint of a drive shaft of the vehicle. For the torque-transmitting connection, the joint bell is extended towards the outside of the vehicle in the transverse direction of the vehicle with an axle journal, which is interlocked with the internal circumference of the hollow cylindrical hub portion of the wheel hub. In addition, the internal ring or rings of the wheel bearing are preloaded axially against an axial abutment of the bearing seat of the hub portion of the wheel hub by means of the joint bell. To simplify assembly, the splines have a toothing clearance in the circumferential direction.

Particularly in electric vehicles with high torques during drive and recuperation, cracking noises occur when the direction of rotation of the drive shaft is reversed, as the joint bell of the constant velocity joint (i.e. external drive shaft joint) twists. This results in a relative movement between the axle journal and the hub portion. Accordingly, there is also relative movement at the contact surfaces between the joint bell and the internal ring as well as between the internal ring and the hub, which generates the cracking noises.

In the prior art, the generation of such cracking noises can be reduced by providing different measures: For example, axial toothing can be provided between one end face of the hub portion and the joint bell. Such axial toothing requires more axial installation space, which has a negative impact on the vehicle's turning circle. In addition, the axial toothing is more complex to manufacture, as the axial toothing must be sealed and is more difficult to install (for example in a tooth-to-tooth position). Alternatively, a sliding washer can be used on the contact surfaces. The use of such a sliding washer requires additional installation space and reduces the transmittable torque via the frictional connection, so that the joint bell must be designed to be more robust and heavier. As a further alternative, the wheel bearing can be lubricated or bonded in the region of the contact surfaces. Such lubrication/gluing causes additional work and contamination during production.

A wheel bearing unit for a vehicle is known from JP 2005308151 A. The wheel bearing unit is designed in such a way that impairment of durability due to corrosion and hydrogen embrittlement is prevented. Another wheel bearing unit is known from US 2005/0254741 A1, in which an internal ring of the wheel bearing is coated with a thin layer. This has zinc flakes or a zinc-nickel or ceramic-based coating. The coating is applied by an immersion process.

### SUMMARY

The object of the invention is to provide a wheel bearing unit for a vehicle in which, compared to the prior art, noise development can be avoided in a structurally simple manner when the direction of rotation of the drive shaft is reversed, in particular without any negative influence on the vehicle turning circle.

The invention is based on a wheel bearing unit the wheel bearing of which has an external ring that can be connected to a wheel carrier in a rotationally fixed manner, for example, as well as at least one internal ring arranged fixedly on a bearing seat of a hollow cylindrical hub portion of a wheel hub, with rolling elements rolling between the internal ring and external ring. The hub portion is connected in a torque-transmitting manner to a joint bell of a constant velocity joint of a drive shaft of the vehicle. In addition, the joint bell preloads the internal ring axially against an axial abutment of the bearing seat of the hub portion of the wheel hub. According to the characterizing part of claim 1, the contact surfaces between the internal ring and the bearing seat and/or between the internal ring and the joint bell are coated with an adhesive friction-reducing layer. In this way, cracking noises can be prevented when the direction of rotation of the drive shaft is reversed, in particular due to a stick-slip effect occurring at the contact surfaces. The internal ring in particular is preferably coated with the adhesive friction-reducing layer on its contact surfaces. In contrast, the contact surfaces on the bearing seat of the wheel hub and on the joint bell can remain uncoated. The wheel hub and the joint bell therefore do not have to be subjected to an additional separate manufacturing step in order to be coated with the adhesive friction-reducing layer.

The bearing seat consists of the axial abutment, against which the internal ring is preloaded, and a radial seat region on the external circumference of the hub portion. To avoid cracking noises, it is advantageous if the contact surface between the internal ring and the axial abutment and/or the contact surface between the internal ring and the radial seat region of the bearing seat and/or the contact surface between the internal ring and the joint bell are coated with the adhesive friction-reducing layer.

In view of a simple torque transmission between the drive shaft-side joint bell and the wheel hub, the joint bell can be extended towards the outside of the vehicle in the transverse direction of the vehicle with an axle journal. This can be brought into force-transmitting coupling in splines on the internal circumference of the hollow cylindrical hub portion of the wheel hub.

If the direction of rotation of the drive shaft is reversed, a stick-slip effect can occur, which leads to the cracking noises. With such a stick-slip effect, when a breakaway torque is reached, a relative movement occurs between the joint bell and the hub portion, in particular due to torsion of the drive shaft and/or due to a residual play between the axle journal of the drive shaft and the hub portion. The adhesive friction-reducing layer according to the invention can be used to adjust a coefficient of friction at the contact surfaces, in particular to reduce it in order to prevent the cracking noises.

The axial preload of the internal ring against the bearing seat of the wheel hub can be achieved by means of a central screw. The central screw is inserted into the hollow cylindrical hub portion of the wheel hub in alignment with the axis of rotation of the wheel hub from the outside of the vehicle in the transverse direction of the vehicle and can be screwed to an internal thread of the axle journal. The screw head of the central screw can be supported on the outside of the vehicle on the wheel hub, so that an axial interference fit consisting of the central screw, the wheel hub, the internal ring and the axle journal together with the joint bell is realized. Alternatively, the axial preload of the internal ring against the bearing seat of the wheel hub can be achieved by means of a central nut, which is screwed to an external thread of the axle journal of the joint bell.

In a preferred embodiment, the adhesive friction-reducing layer can be a thin layer with a layer thickness of less than 25 μm, in particular, to save installation space. In contrast to prior art (when using a sliding disk), no structural measures need to be taken on a conventional wheel bearing unit when using such a thin layer in order to apply the adhesive friction-reducing layer. In order not to impair the functionality of the wheel bearing, it is preferable if the internal ring is only coated on the contact surfaces to the hub-side bearing seat and to the joint bell. In contrast, the rolling element track surfaces and the seal seat can remain uncoated.

In a generic method for manufacturing the wheel bearing arrangement according to the invention, pre-processing steps can first be carried out in a process sequence, by means of which an internal ring blank is produced. Such pre-processing steps are, for example, forging, rolling, turning, heat treatment, precision turning and grinding of the internal ring end face and/or the internal ring internal circumference. In the further course of the process, following process steps can be carried out, namely rolling track grinding and honing of the internal ring and a final bearing assembly, in which among other things the finished internal ring is mounted on the bearing seat of the hollow cylindrical hub portion.

In terms of production technology, it is advantageous if the adhesive friction-reducing layer is applied during a coating process, preferably before the rolling track grinding and honing is carried out. In this case, the entire external surface of the internal ring blank can first be coated with the adhesive friction-reducing layer during the coating process. The adhesive friction-reducing layer can then be removed from the rolling element rolling track by subsequent rolling track grinding and honing, which prevents the applied layer from impairing the function of the wheel bearing. In terms of manufacturing technology, the coating process can be a dipping process. The adhesive friction-reducing coating can preferably be a zinc flake/zinc-nickel coating or a ceramic-based coating.

### BRIEF DESCRIPTION OF THE FIGURES

An exemplary embodiment of the invention is described below with reference to the attached figures.

In particular:

FIG. 1 is a sectional view of a wheel bearing unit;

FIG. 2 is a detailed view of an internal ring of the wheel bearing;

FIG. 3 is a detailed view of an internal ring of the wheel bearing;

FIG. 4 shows a further embodiment of the invention; and

FIG. 5 shows a further embodiment of the invention.

### DETAILED DESCRIPTION

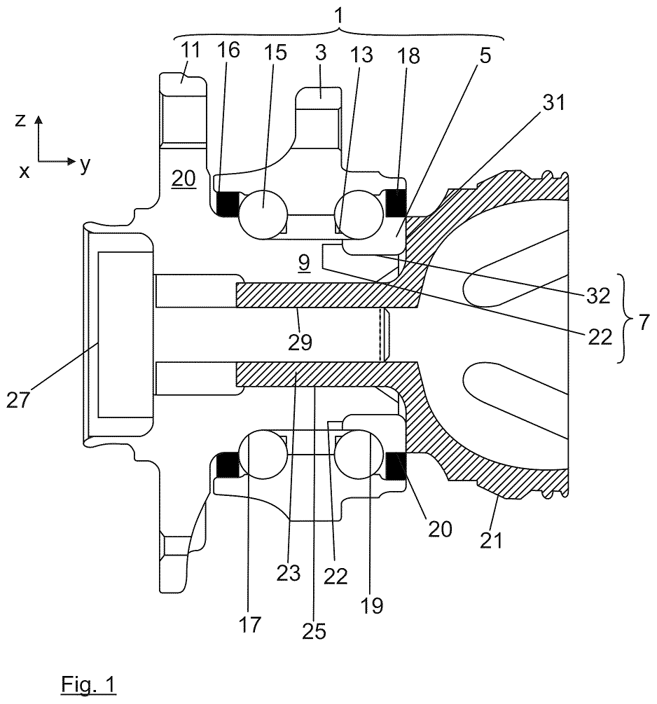

FIG. 1 shows a wheel bearing unit with a wheel bearing 1. The wheel bearing 1 has an external ring flange 3 that can be mounted non-rotatably, for example on a wheel carrier. In addition, the wheel bearing 1 has an internal ring 5, which is firmly arranged on a bearing seat 7 of a hollow cylindrical hub portion 9 of a wheel hub 11. The wheel bearing 1 is provided with two rows of balls 15 running in cages 13, each of which runs on an external rolling track 17 directly on the external circumference of the hollow cylindrical hub portion 9 and on an internal rolling track 19, which is formed on the internal ring 5. The hollow cylindrical hub portion 9 merges in the transverse direction y towards the outside of the vehicle into an extended wheel flange 20, on which a rim of the vehicle wheel and a brake disk can be mounted via wheel bolts.

According to FIG. 1, a joint bell 21 of a drive shaft not shown is extended towards the outside of the vehicle with an axle journal 23, which projects into the hollow cylindrical hub portion 9 and is in mating teeth 25 with its internal circumference. The joint bell 21 is axially preloaded against one end face of the internal ring 5 by means of an indicated central screw 27. The central screw 27 is inserted into the hollow cylindrical hub portion 9 of the wheel hub 11 from the outside of the vehicle in the transverse direction y and is in screw connection with an internal thread 29 of the axle journal 23, while its screw head is supported on the outside of the wheel hub 11. The intermediate bearing space between the external ring flange 3 and the internal ring 5 or the external circumference of the hollow cylindrical hub portion 9 is sealed with an external ring seal 16 and an internal ring seal 18. The internal ring seal 18 is supported on a seal seat 20 of the internal ring 5. As can also be seen from FIG. 1, the bearing seat 7 is formed by an axial abutment 22, against which the internal ring 5 is axially preloaded, and by a radial seat region 32 on the external circumference of the hub portion 9.

In an electric vehicle with high torques during drive and recuperation, torsion of the joint bell 21 occurs when the direction of rotation is reversed. In the prior art, the reversal of the direction of rotation of the drive shaft leads to a stick-slip effect, which generates cracking noises. In the case of the stick-slip effect, the torsion of the joint bell 21 and/or residual play causes a relative movement between the joint bell 21 and the hub portion 9. In the prior art, the cracking noises occur when a breakaway torque is exceeded at the contact surface between the joint bell 21 and the internal ring 5, or at the contact surface between the internal ring 5 and the radial seating region 32 of the bearing seat 7, or at the contact surface between the internal ring 5 and the axial abutment 22 of the bearing seat 7.

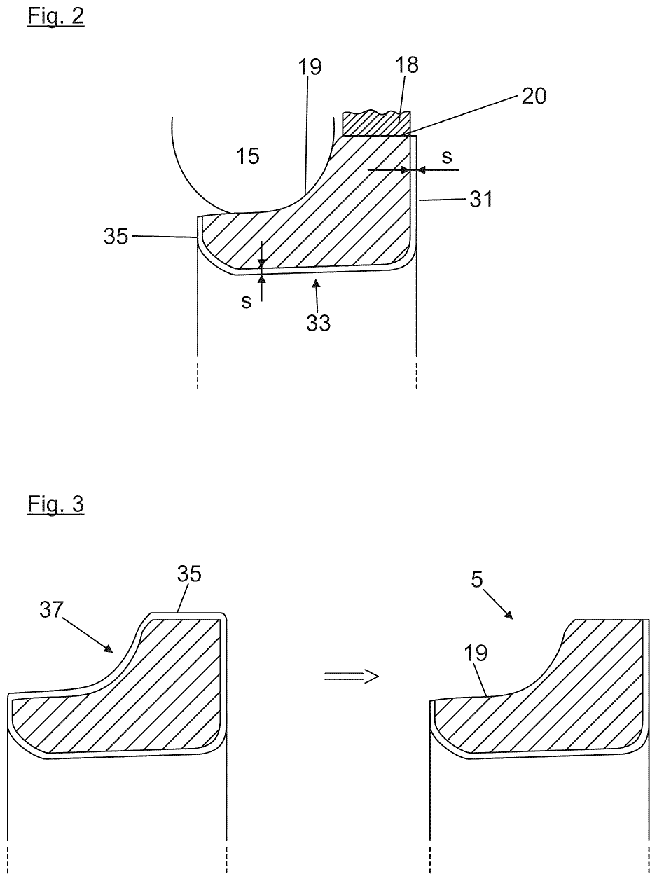

Such cracking noises can be prevented according to the invention by the following measure: the internal ring 5 as shown in FIG. 2 has an adhesive friction-reducing layer 35 on its contact surface 31 to the joint bell 21, on its contact surface 33 to the radial seating region 32 of the bearing seat 7 and on its contact surface to the axial abutment 22. By means of the adhesive friction-reducing layer 35, a coefficient of friction can be set on the contact surfaces in order to prevent the cracking noises. As can also be seen in FIG. 2, the internal ring 5 is only coated with the adhesive friction-reducing layer 35 on its contact surfaces, while the internal rolling track 19 and the seal seat 20 of the internal ring 5 are uncoated. The adhesive friction-reducing layer 35 is preferably a thin layer with a layer thickness s of less than 25 μm.

Preferably, the internal ring 5 according to the invention can be manufactured according to the following process chain: First, pre-machining steps are carried out to produce an internal ring blank 37 (FIG. 3), in particular forging, rolling, turning, heat treatment, precision turning and grinding of the internal ring end face and/or the internal ring internal circumference. The internal ring blank 37 produced in this way is then subjected to rolling track grinding and honing in order to produce the rolling element external rolling track 19 and the seal seat 20. According to the invention, a coating process follows before the rolling track grinding and honing, in which (for example in a dipping process) the internal ring blank 37 is completely provided with the adhesive friction-reducing layer 35, as shown in FIG. 3.

After the coating process, the rolling track grinding and honing of the internal rolling track 19 of the internal ring 5 is carried out, whereby the layer 35 on the internal rolling track 19 and also on the seal seat 20 is removed. The finished internal ring 5 is then mounted on the bearing seat 7 of the hollow cylindrical hub portion 9 of the wheel hub 11 in a bearing assembly.

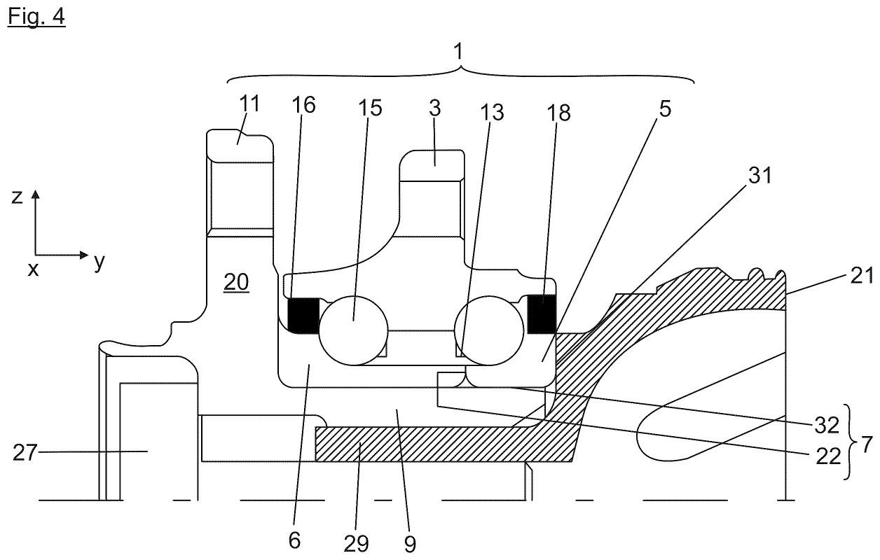

FIG. 4 shows a second embodiment of the invention, the structure and mode of operation of which are essentially identical to the embodiment shown in FIGS. 1 to 3, so that reference can be made to the preliminary description. In contrast to the first exemplary embodiment, in FIG. 4 the external rolling track 17 is not formed directly on the external circumference of the hollow cylindrical hub portion 9, but on an internal ring 6, which is arranged together with the internal ring 5 on the bearing seat 7. In this case, the external internal ring 6 forms the axial abutment 22 for the internal ring 5 inside the vehicle.

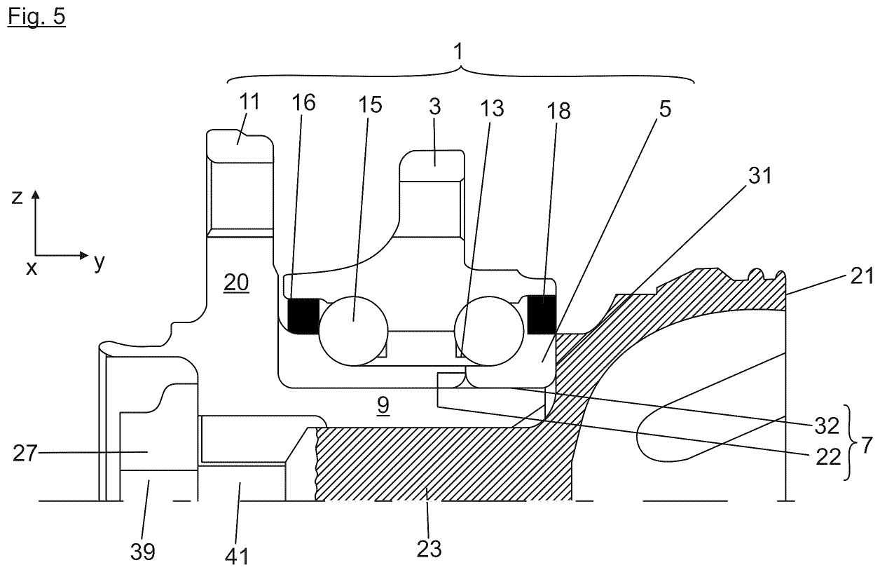

FIG. 5 shows a third embodiment of the invention, the structure and mode of operation of which are also largely identical to the embodiment shown in FIGS. 1 to 3, so that reference can again be made to its preliminary description. In contrast to the first exemplary embodiment, in FIG. 5 the joint bell 21 is not preloaded axially against an end face of the internal ring 5 by means of a central screw 27. Instead, in FIG. 5, the axial preload of the internal ring 5 against the axial abutment 22 of the bearing seat 7 is achieved by means of a central nut 39, which is screwed to an external thread 41 of the axle journal 23 of the joint bell 21.

### REFERENCE LIST

1 Wheel bearing
3 External ring
5 Internal ring
7 Bearing seat
9 Hollow cylindrical hub portion
11 Wheel hub
13 Cage
15 Ball
16 External ring seal
17 External rolling track
18 Internal ring seal
19 Internal rolling track
20 Seal seat
21 Joint bell
22 Axial abutment
23 Axle journal
25 Splines
27 Central screw
29 Internal thread
31, Contact surface
32 Radial seating region of the bearing seat 7
33 Contact surface
35 Friction-reducing layer
37 Internal ring blank
39 Central nut
41 External thread
s Layer thickness

1-10. (canceled)

11. A wheel bearing unit for a vehicle, comprising: a wheel bearing which has at least one internal ring arranged fixedly on a bearing seat of a hollow-cylindrical hub portion of a wheel hub, wherein the hub portion can be connected in a torque-transmitting manner to a joint bell of a constant velocity joint of a cardan shaft of the vehicle, and wherein the joint bell preloads the internal ring axially against the bearing seat of the hub portion of the wheel hub, and
contact surfaces between the internal ring and the bearing seat and/or between the internal ring and the joint bell are coated with an adhesive friction-reducing layer, as a result of which, in the event of a reversal of the direction of rotation at the cardan shaft, cracking noises are avoided, in particular due to a stick-slip effect occurring at the contact surfaces, and/or that a coefficient of friction can be set on the contact surfaces, in particular by the adhesive friction-reducing layer, in order to prevent the clicking noises.

12. The wheel bearing unit according to claim 11, wherein the internal ring is coated with the adhesive friction-reducing layer on its contact surfaces, while the bearing seat of the wheel hub and the joint bell remain uncoated.

13. The wheel bearing unit according to claim 11, wherein for the torque-transmitting connection, the joint bell is extended in the transverse direction of the vehicle towards the outside of the vehicle with an axle journal, which is in plug-in toothing with the internal circumference of the hollow cylindrical hub portion of the wheel hub.

14. The wheel bearing unit according to claim 13, wherein the reversal of the direction of rotation results in a relative movement between the joint bell and the hub portion, in particular due to torsion of the drive shaft and/or due to a residual play between the axle journal of the joint bell and the hub portion.

15. The wheel bearing unit according to claim 11, wherein the joint bell can be axially preloaded against the internal ring by a central screw, and the central screw can be screwed in the transverse direction of the vehicle from the outside of the vehicle to an internal thread of the axle journal and can be supported with its screw head on the wheel hub, or alternatively that the axial preload of the internal ring against the bearing seat of the wheel hub is effected by a central nut which can be screwed to an external thread of the axle journal of the joint bell.

16. The wheel bearing unit according to claim 11, wherein the adhesion-reducing layer is a thin layer with, in particular, a layer thickness of less than 25 μm.

17. The wheel bearing unit according to claim 11, wherein the internal ring is coated only on the contact surfaces, while rolling element tracks of the internal ring are free of coating.

18. A method for manufacturing a wheel bearing arrangement according to claim 11, wherein pre-processing steps for producing an internal ring blank are carried out in a process sequence, in particular forging, rolling, turning, heat treatment, precision turning and grinding of the internal ring end face and/or the internal ring internal circumference, and the following process steps are carried out in the further course of the process:
grinding and honing of the rolling element rolling track, and finally
bearing assembly, in which, among other things, the internal ring is mounted on the bearing seat of the hollow cylindrical hub portion.

19. The method according to claim 18, wherein a coating process in which the internal ring blank is provided with the adhesive friction-reducing layer takes place before the rolling track grinding and honing is carried out, and that in particular the layer is removed from the rolling element rolling track and in particular from the seal seat during the rolling track grinding and honing.

20. The method according to claim 19, wherein the coating process is a dipping process, and/or that the adhesive friction-reducing layer is a zinc flake/zinc-nickel coating or a ceramic-based coating.

21. The wheel bearing unit according to claim 12, wherein for the torque-transmitting connection, the joint bell is extended in the transverse direction of the vehicle towards the outside of the vehicle with an axle journal, which is in plug-in toothing with the internal circumference of the hollow cylindrical hub portion of the wheel hub.

22. The wheel bearing unit according to claim 12, wherein the joint bell can be axially preloaded against the internal ring by a central screw, and the central screw can be screwed in the transverse direction of the vehicle from the outside of the vehicle to an internal thread of the axle journal and can be supported with its screw head on the wheel hub, or alternatively that the axial preload of the internal ring against the bearing seat of the wheel hub is effected by a central nut which can be screwed to an external thread of the axle journal of the joint bell.

23. The wheel bearing unit according to claim 13, wherein the joint bell can be axially preloaded against the internal ring by a central screw, and the central screw can be screwed in the transverse direction of the vehicle from the outside of the vehicle to an internal thread of the axle journal and can be supported with its screw head on the wheel hub, or alternatively that the axial preload of the internal ring against the bearing seat of the wheel hub is effected by a central nut which can be screwed to an external thread of the axle journal of the joint bell.

24. The wheel bearing unit according to claim 14, wherein the joint bell can be axially preloaded against the internal ring by a central screw, and the central screw can be screwed in the transverse direction of the vehicle from the outside of the vehicle to an internal thread of the axle journal and can be supported with its screw head on the wheel hub, or alternatively that the axial preload of the internal ring against the bearing seat of the wheel hub is effected by a central nut which can be screwed to an external thread of the axle journal of the joint bell.

25. The wheel bearing unit according to claim 12, wherein the adhesion-reducing layer is a thin layer with, in particular, a layer thickness of less than 25 μm.

26. The wheel bearing unit according to claim 13, wherein the adhesion-reducing layer is a thin layer with, in particular, a layer thickness of less than 25 μm.

27. The wheel bearing unit according to claim 14, wherein the adhesion-reducing layer is a thin layer with, in particular, a layer thickness of less than 25 μm.

28. The wheel bearing unit according to claim 15, wherein the adhesion-reducing layer is a thin layer with, in particular, a layer thickness of less than 25 μm.

29. The wheel bearing unit according to claim 12, wherein the internal ring is coated only on the contact surfaces, while rolling element tracks of the internal ring are free of coating.

30. The wheel bearing unit according to claim 13, wherein the internal ring is coated only on the contact surfaces, while rolling element tracks of the internal ring are free of coating.
